(19) United States
(12) Patent Application Publication
(10) Pub. No.: US 2006/0104535 A1
(43) Pub. Date: May 18, 2006

(54) Method and apparatus for removing false edges from a segmented image

(76) Inventor: Christiaan Varekamp, Veldhoven (NL)

Correspondence Address: PHILIPS INTELLECTUAL PROPERTY & STANDARDS, 595 MINER ROAD, CLEVELAND, OH, 44143, US

(21) Appl. No.: 10/537,209

(22) PCT Filed: Dec. 4, 2003
(86) PCT No.: PCT/IB03/05677

§ 371 Date: Jun. 3, 2005

(51) Int. Cl. G06K 9/40; G06K 9/34

(52) U.S. Cl. 382/260; 382/275; 382/171

(57) ABSTRACT

In a method for processing one or more images, an image is segmented into a segmentation map including a plurality of pixel groups separated by edges, including at least some false edges. The segmentation map is filtered to remove the false edges. The segmentation step is repeated to generate an output segmentation map.

The present invention relates generally to the art of image and video processing. It particularly relates to region-based segmentation and filtering of images and video and will be described with particular reference thereto.

Video sequences are used to estimate the time-varying, three-dimensional (3D) structure of objects from the observed motion field. Applications that benefit from a time-varying 3D reconstruction include vision-based control (robotics), security systems, and the conversion of traditional monoscopic video (2D) for viewing on a stereoscopic (3D) television. In this technology, structure from motion methods are used to derive a depth map from two consecutive images in the video sequence.

Image segmentation is an important first step that often precedes other tasks such as segment based depth estimation. Generally, image segmentation is the process of partitioning an image into a set of non-overlapping parts, or segments, that together correspond as much as possible to the physical objects that are present in the scene. There are various ways of approaching the task of image segmentation, including histogram-based segmentation, traditional edge-based segmentation, region-based segmentation, and hybrid segmentation. However, one of the problems with any segmentation method is that false edges may occur in a segmented image. These false edges may occur for a number of reasons, including that the pixel color at the boundary between two objects may vary smoothly instead of abruptly, resulting in a thin elongated segment with two corresponding false edges instead of a single true edge. The problem tends to occur at defocused object boundaries or in video material that has a reduced spatial resolution in one or more of the three color channels. The problem of false edges is particularly troublesome with the conversion of traditional 2D video to 3D video for viewing on a 3D television.

Several methods have been proposed to detect false edges in other applications. For example, U.S. Pat. No. 5,268,967 discloses a digital image processing method which automatically segments the desired regions in a digital radiographic image from the undesired regions. The method includes the steps of edge detection, block generation, block classification, block refinement and bit map generation.

U.S. Pat. No. 5,025,478 discloses a method and apparatus for processing a picture signal for transmission in which the picture signal is applied to a segmentation device, which identifies regions of similar intensity. The resulting region signal is applied to a modal filter in which region edges are straightened and then sent to an adaptive contour smoothing circuit where contour sections that are identified as false edges are smoothed. The filtered signal is subtracted from the original luminance signal to produce a luminance texture signal which is encoded. The region signal is encoded together with flags indicating which of the contours in the region signal represent false edges.

Published PCT application WO 00/77735 discloses an image segmenter that uses a progressive flood fill to fill incompletely bounded segments and scale transformations and guiding segmentation at one scale with segmentation results from another scale, detects edges using a composite image that is a composite of multiple color planes, generates edge chains using multiple classes of edge pixels, generates edge chains using the scale transformations, and filters false edges at one scale based on edges detected at another scale.

However, the prior art only involves edge detection and/or smoothing of the false edges. None of the inventions actually remove the false edges from the segmented image, such as through the use of a filter that operates only on the segmentation map. The present invention contemplates an improved apparatus and method that overcomes the aforementioned limitations and others.

According to one aspect of the invention, an imaging process apparatus is provided. A segmenting means is provided for segmenting an image into a segmentation map including a plurality of pixel groups separated by edges including at least some false edges. A filtering means is provided for filtering the segmentation map to remove the false edges, the filtering means outputting the filtered segmentation next to the segmentation means for presegmentation.

According to another aspect of the invention, a method for processing one or more images is provided. An image is segmented into a segmentation map including a plurality of pixel groups separated by edges including at least some false edges. The segmentation map is filtered to remove the false edges. The segmentation step is repeated to generate an output image.

One advantage of the present invention resides in improving the segmentation quality for the conversion of 2D video material to 3D video.

Another advantage of the present invention resides in improving video image segmentation quality at object edges.

Yet another advantage of the present invention resides in decreasing edge coding cost for image and video compression.

Numerous additional advantages and benefits of the present invention will become apparent to those of ordinary skill in the art upon reading the following detailed description of the preferred embodiment.

The invention may take form in various components and arrangements of components, and in various steps and arrangements of steps. The drawings are only for the purpose of illustrating preferred embodiments and are not to be considered as limiting the invention.

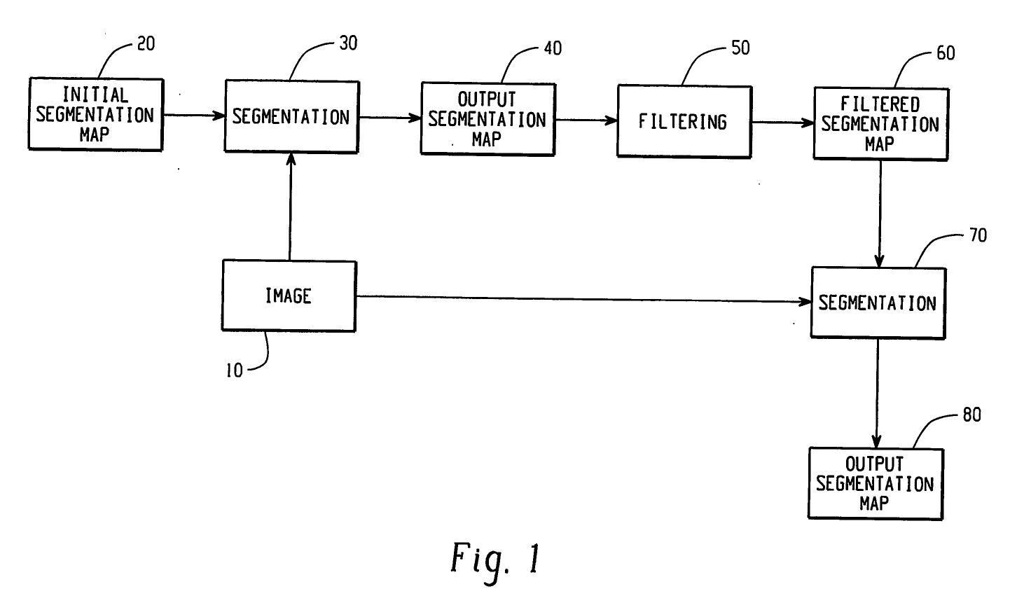

FIG. 1 shows an image segmentation method with a false edge removal filter between segmentation steps.

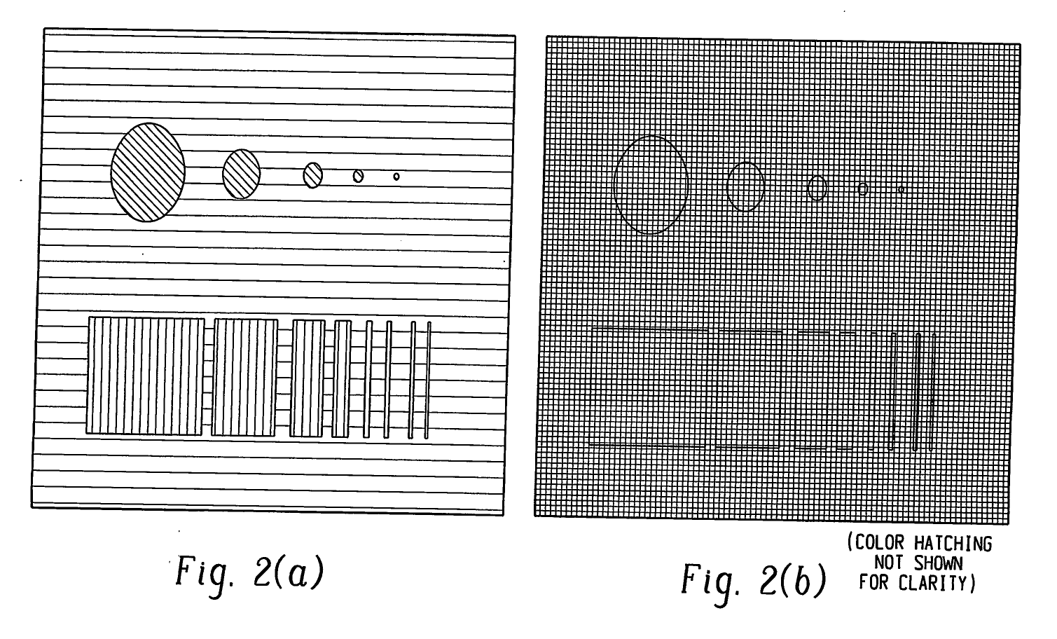

FIG. 2(a) shows an example of an input image.

FIG. 2(b) shows an example of an initial segmentation map with square regions of 5×5 pixels.

FIG. 2(c) shows an example of an output segmentation map with false edges.

FIG. 2(d) shows an example of a filtered segmentation map with false edges removed.

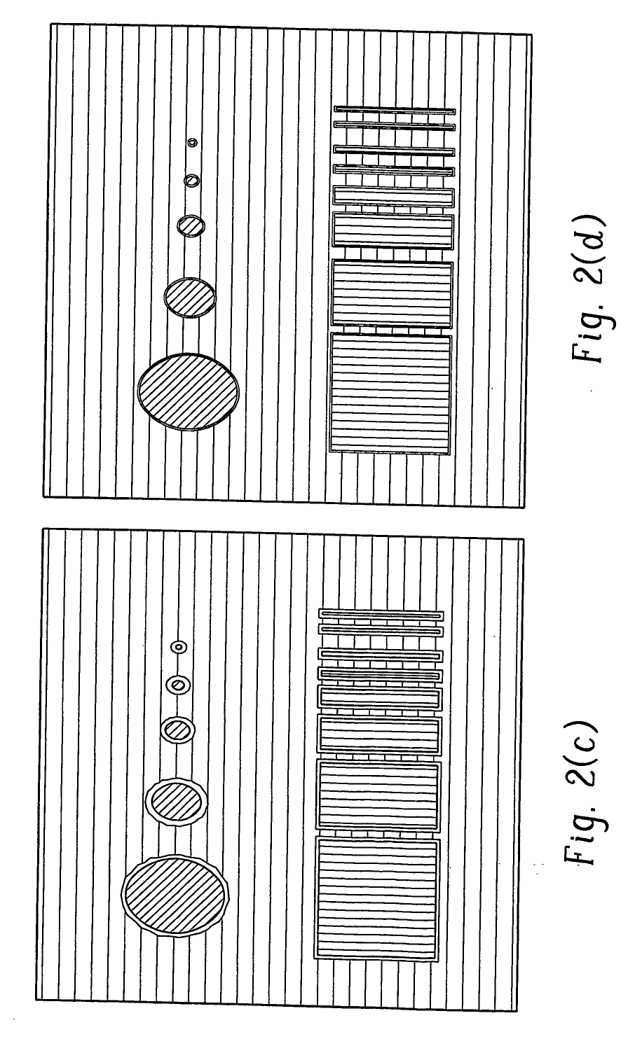

FIG. 3 shows an exemplary false edge removal filtering method.

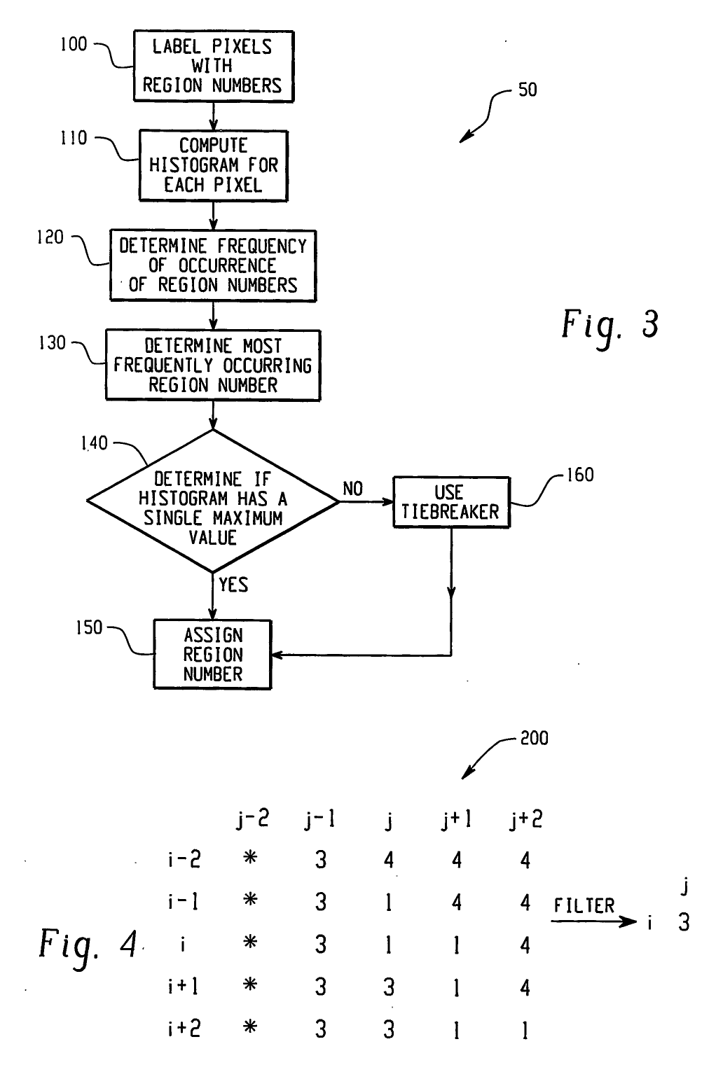

FIG. 4 shows an example of a 5×5 pixel window, centered at pixel location (i,j).

An important step in converting 2D video to 3D video is the identification of image regions with homogeneous color, i.e., image segmentation. Depth discontinuities are assumed to coincide with the detected edges of homogeneous color regions. A single depth value is estimated for each color region. This depth estimation per region has the advantage that there exists per definition a large color contrast along the region boundary. The temporal stability of color edge positions is critical for the final quality of the depth maps. When the edges are not stable over time, an annoying flicker may be perceived by the viewer when the video is shown on a 3D color television. Thus, a time-stable segmentation method is the first step in the conversion process from 2D to 3D video. Region-based image segmentation using a constant color model achieves this desired effect. This method of image segmentation is described in greater detail below.

The constant color model assumes that the time-varying image of an object region can be described in sufficient detail by the mean region color. An image is represented by a vector-valued function of image coordinates:
I(x,y)=(r(x,y),g(x,y),b(x,y)) (1),
where r(x,y), g(x,y) and b(x,y) are the red, green and blue color channel. The object is to find a region partition referred to as segmentation l consisting of a fixed number of regions N. The optimal segmentation lₒₚₜ is defined as the segmentation that minimizes the sum of an error term plus a regularization term f(x,y) over all pixels in the image:

$${l}_{opt} = {arg min}_{l} {\sum }_{( x , y )} [ e ( x , y ) + kf ( x , y ) ] , \qquad ( 2 )$$

where k is a regularization parameter that weights the importance of the regularization term. Equations for a simple and efficient update of the error criterion when one sample is moved from one cluster to another cluster are derived by Richard O. Duda, Peter E. Hart, and David G. Stork in “Pattern Classification,” pp. 548-549, John Wiley and Sons, Inc., New York, 2001. These derivations were applied in deriving the equations of the segmentation method. Note that the regularization term is based on a measure presented by C. Oliver and S. Quegan in “Understanding Synthetic Aperture Radar Images,” Artech-House, 1998. The regularization term limits the influence that random signal fluctuations (such as sensor noise) have on the edge positions. The error e(x,y) at pixel position (x,y) depends on the color value I(x,y) and on the region label l(x,y):
e(x,y)=∥I(x,y)−m_{l(x,y)}∥₂² (3),
where m_{c} is the mean color for region c and l(x,y) is the region label at position (x,y) in the region label map. The subscript at the double vertical bars denotes the Euclidian norm. The regularization term f(x,y) depends on the shape of regions:

$$f ( x , y ) = {\sum }_{( {x}^{′} , {y}^{′} )} χ ( l ( x , y ) , l ( {x}^{′} , {y}^{′} ) ) , \qquad ( 4 )$$

where (x′,y′) are coordinates from the 8-connected neighbor pixels of (x,y). The value of X(A,B) depends on whether region labels A and B differ:

$$χ ( A , B ) = \{ \begin{matrix}1 & if A \neq B \\ 0 & otherwise\end{matrix} . \qquad ( 5 )$$

Function f(x,y) has a straightforward interpretation. For a given pixel position (x,y), the function simply returns the number of 8-connected neighbor pixels that have a different region label.

The segmentation is initialized with a square tessellation. Given the initial segmentation, a change is made at a region boundary by assigning a boundary pixel to an adjoining region. Suppose that a pixel with coordinates (x,y) currently in region with label A is tentatively moved to region with label B. Then the change in mean color for region A is:

$$Δ {m}_{A} = - \frac{I ( x , y ) - {m}_{A}}{{n}_{A} - 1} , \qquad ( 6 )$$

and the change in mean color for region B is:

$$Δ {m}_{B} = - \frac{I ( x , y ) - {m}_{B}}{{n}_{B} + 1} , \qquad ( 7 )$$

where n_{A} and n_{B} are the number of pixels inside regions A and B respectively. The proposed label change causes a corresponding change in the error function given by

$$Δ e = \frac{{n}_{B}}{{n}_{B} + 1} {‖ I ( x , y ) - {m}_{B} ‖}_{2}^{2} - \frac{{n}_{A}}{{n}_{A} - 1} {‖ I ( x , y ) - {m}_{A} ‖}_{2}^{2} . \qquad ( 8 )$$

The proposed label change from A to B at pixel (x,y) also changes the global regularization function f. The proposed move affects f not only at (x,y), but also at the 8-connected neighbor pixel positions of (x,y). The change in regularization function is given by the sum

$$Δ f = 2 {\sum }_{( {x}^{′} , {y}^{′} )} χ ( B , l ( {x}^{′} , {y}^{′} ) ) - χ ( A , l ( {x}^{′} , {y}^{′} ) ) , \qquad ( 9 )$$

where the summation is over all 8-connected neighbor positions denoted by (x′,y′) This simple form for the change Δf follows from the fact that x is symmetric:
X(A,B)=X(B,A). (10).
The proposed label change improves the fit criterion if Δe+kΔf<0. Finally, regions are merged.

The above procedure for updating the segmentation map and accepting the proposed update when it improves the fit of model to data is done for each image in the sequence separately. Only after the merge step are the region mean values updated with a new image that is read from the video stream. The region fitting and merging starts again for the new image.

With reference to FIG. 1, a region-based segmentation operation 30, preferably based upon the constant color model, takes as its inputs a color image 10 and an initial segmentation map 20. The output of the segmentation operation 30 is a segmentation map 40, which shows the objects found in the image. An example of the input color image 10 is illustrated in FIG. 2(a). There, an image is of a series of ovals decreasing in size as well as a series of rectangles decreasing in size. The image is segmented into square regions of 5×5 pixels in the exemplary embodiment shown in FIG. 2(b). An example of the output segmentation map 40 is illustrated in FIG. 2(c).

The false edges that may occur in a segmented image are best seen in FIG. 2(c). These false edges can occur because of defocus at the boundary between two objects. False edges can also occur because many films have a reduced spacial resolution of the color channels.

Furthermore, color undersampling causes problems for segmentation algorithms. While a segmentation algorithm tries to detect edges with high accuracy, a spatial undersampling of the signal generally occurs and results in small and elongated regions near object boundaries. This unwanted effect is best illustrated in FIG. 2(c). Multiple edges, which are coded in white, are visible near object boundaries. These small and elongated regions are removed by adding a false edge removal filter step 50 between segmentation steps. The result of applying the filter 50 to the image data as shown in FIG. 2(c) is shown in FIG. 2(d).

Image segmentation applications require a small number of regions with high edge accuracy. For example, accurate edges are a requirement for the accurate conversion of 2D monoscopic video to 3D steroscopic video. For such an application, segmentation is used for depth estimation and a single depth value is assigned to each region in the segmented image. The edge position and its temporal stability are then important for the perceptual quality of the 3D video.

A solution to the problem of false edges is the addition of the false edge removal filter step 50 between segmentation operations. With reference to FIG. 1, the preferred embodiment includes the color image 10, the initial segmentation map 20, the segmentation step 30, the first output segmentation map 40, the false edge removal filter step 50, a filtered segmentation map 60, a second segmentation step 70, and a second output segmentation map 80. The filter 50 operates on the segmentation map 40 and is thus independent of the color image 10.

With reference to FIG. 3, the operation of the false edge removal filter 50 is described as follows. In a step 100, each pixel (i,j) of the output segmentation map 40 is labeled with a region number (or segment label), depending on its color. The value assigned to each region number k is an arbitrary integer. In a step 110, for each pixel (i,j) a histogram of the segment labels is computed inside a square window w. The histogram is represented by the vector
[hₖ], 1≦k<n (11),
where hₖ is the frequency of region number k inside the window w, and n is the total number of regions in the segmentation. In a step 120, the frequency of occurrence for each region number is determined. In a step 130, the most frequently occurring region number is determined. In a step 140, a determination is made whether the histogram has a single maximum value. If so, in a step 150 the filtered segmentation map at pixel (i,j) is given by the region number kₘₐₓ for which the maximum occurs as follows:
kₘₐₓ=arg max([hₖ]) (12).

However, it may be the case that two or more region numbers have the same frequency and that this frequency is higher than the frequency of all other numbers inside the window w. In that situation, a tiebreaker 160 is used, such as assigning the smallest of the equally frequent region numbers to the output segmentation or assigning the largest region number to the output segmentation.

FIG. 4 is an illustration of an exemplary 5×5 pixel window 100, centered at pixel location (i,j). However, in the alternative, other window sizes, such as a 3×3 pixel window, are also contemplated. On the left-hand side of the filter operation is the window 100 with the input region numbers. Pixel locations containing an asterisk (*) lie outside the image plane. That is, the illustrated example is of the edge of the picture. Region numbers at these pixel locations are ignored when constructing the histogram. The filter operation gives as an output the number 3. This result can be verified by counting the frequency for each region number in the input window:
[hₖ]=(h₁,h₂,h₃,h₄ . . . ,hₙ)=(6,0,7,7, . . . ,0) (13).

In this example, there is more than one global maximum value in the histogram. That is, region numbers 3 and 4 both have a frequency of 7. The smaller region number (k=3) is selected by the tiebreaker as the answer and assigned to the output segmentation at pixel location (i,j). However, in the alternative, the larger region number (k=4) could have also been selected and assigned to the output segmentation at pixel location (i,j). The false edge removal filter step 50 is repeated until all of the pixels (i,j) in the segmentation map 40 have been analyzed.

Any number of region segmentation methods may be used so long as the method is able to iteratively fit (or update) the region boundaries given an initial segmentation. The false edge removal filter 50 not only removes small and elongated regions, but can also distort region boundaries. Thus, the distortion is corrected by running the segmentation operation 70 again after having applied the filter operation.

The filtered and segmented image map is loaded into the filtered segmentation map or memory space 60. A second segmentation process 70 is performed to re-segment the map 60 to generation output map 80. Potentially, the filtering and segmenting steps are repeated one or more times.

Applications for the false edge removal filter include improving the segmentation quality for the conversion of existing 2D video material to 3D video; improving video image quality at object edges (edge sharpening algorithms); and decreasing edge coding cost for image and video compression.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. An image processing apparatus comprising:
a first segmentation means for segmenting one or more images into an output segmentation map including a plurality of pixel groups separated by edges including at least some false edges;
a filtering means for filtering the segmentation map to remove the false edges, the filtering means outputting the filtered segmentation next to a second segmentation means for re-segmentation.

2. The image processing apparatus as set forth in claim 1, wherein the first and second segmentation means use a constant color model, the constant color model including an identification means for identifying image regions with homogeneous color or grey scale.

3. The image processing apparatus as set forth in claim 1, wherein the pixel groups are initially rectangular shaped regions.

4. The image processing apparatus as set forth in claim 1, wherein the filtering means includes:
a computing means for computing a histogram of the pixel labels inside a window surrounding a given pixel in the segmentation map; and
a first determining means for determining a frequency of occurrence for each pixel label in the window.

5. The image processing apparatus as set forth in claim 4, wherein the filtering means further includes:
a second determining means for determining a most frequently occurring pixel label in the histogram;
an assigning means for assigning to the given pixel in the output segmentation map the pixel label which occurs most frequently.

6. The image processing apparatus as set forth in claim 5, further including a tie breaking means for selecting one of:
a larger of equally, most frequently occurring labels, and
a smaller of equal, most frequently occurring labels, to be assigned to the given pixel when two or more labels occur equally and most frequently.

7. The imaging processing apparatus as set forth in claim 5, further including a tie breaking means for selecting the pixel label to be assigned to the given pixel where two or more pixel labels have the same frequency and the frequency is higher than the frequency of all other pixel labels inside the histogram.

8. The image processing apparatus as set forth in claim 4, wherein the window is a square of 5×5 pixels.

9. The image processing apparatus as set forth in claim 1, wherein the one or more images include frames of a two-dimensional video.

10. A method for processing one or more images, the method including:
segmenting an image into a segmentation map including a plurality of pixel groups separated by edges including at least some false edges;
filtering the segmentation map to remove the false edges; and
repeating the segmenting step to generate an output image.

11. The method for processing one or more images as set forth in claim 10, further including repeating the region segmenting step and the filtering step a plurality of times to further refine the edges.

12. The method for processing one or more images as set forth in claim 10, wherein the segmenting of the image is region-based.

13. The method for processing one or more images as set forth in claim 12, wherein the region-based segmenting step uses a constant color model, the constant color model including the identification of image regions with homogeneous color.

14. The method for processing one or more images as set forth in claim 10, wherein the pixel groups are square regions of 5×5 pixels.

15. The method for processing one or more images as set forth in claim 10, wherein the filtering step includes:
computing a histogram of the pixel labels inside a window for a given output pixel in the segmentation map; and
determining the frequency of occurrence for each pixel label in the window.

16. The method for processing one or more images as set forth in claim 15, wherein the filtering further includes:
determining a most frequently occurring label of the histogram;
assigning to the output pixel the pixel label with the maximum occurrence.

17. The method for processing one or more images as set forth in claim 16, further including when more than one label occurs with equal most frequency assigning the given pixel one of:
the smallest of the equally frequent labels, and
the largest of the equally frequent labels.

18. The method for processing one or more images as set forth in claim 10, wherein the one or more images include frames of a two-dimensional video.
